(19) United States
(12) Patent Application Publication
(10) Pub. No.: US 2024/0414607 A1
(43) Pub. Date: Dec. 12, 2024

(54) METHOD, APPARATUS AND COMPUTER PROGRAM FOR CONDITIONAL HANDOVER

(71) Applicant: Nokia Technologies OY, Espoo (FI)

(72) Inventors: Halit Murat GÜRSU, Munich (DE); Umur KARABULUT, Munich (DE); Panagiotis SPAPIS, Munich (DE); Muhammad TAYYAB, Oulu (FI); Ahmad AWADA, Munich (DE)

(21) Appl. No.: 18/700,518

(22) PCT Filed: Nov. 29, 2021
(86) PCT No.: PCT/EP2021/083322

§ 371 Date: Apr. 11, 2024

(51) Int. Cl. H04W 36/00

(52) U.S. Cl. CPC H04W 36/00837; H04W 36/0058

(57) ABSTRACT

There is provided an apparatus for a terminal, the apparatus comprising means configured to perform: receiving a message from a serving cell, wherein the message comprises a configuration for a measurement event and a configuration for a conditional handover, the configuration for the measurement event comprising a leaving condition. The means are further configured to perform, in response to measuring the leaving condition of the measurement event being met, incrementing a counter, and when it is determined that the counter has reached a threshold value, deactivating the received configuration for the conditional handover and providing a measurement report to the serving cell, the measurement report indicating that the leaving condition of the measurement event has been met.

### FIELD

The present application relates to a method, apparatus, and computer program for a wireless communication system.

### BACKGROUND

A communication system may be a facility that enables communication sessions between two or more entities such as user terminals, base stations/access points and/or other nodes by providing carriers between the various entities involved in the communications path. A communication system may be provided, for example, by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

### SUMMARY

According to an aspect, there is provided an apparatus for a terminal, the apparatus comprising means configured to perform: receiving a message from a serving cell, wherein the message comprises a configuration for a measurement event and a configuration for a conditional handover, the configuration for the measurement event comprising a leaving condition; in response to measuring the leaving condition of the measurement event being met, incrementing a counter; and when it is determined that the counter has reached a threshold value, deactivating the received configuration for the conditional handover and providing a measurement report to the serving cell, the measurement report indicating that the leaving condition of the measurement event has been met.

In an example, the means are configured to perform: activating the received configuration for the conditional handover at the terminal. The activating may be performed before the deactivating. The activating comprising monitoring an execution condition of the conditional handover.

In an example, the threshold value is an integer with a value of two or more.

In an example, the means configured to perform the deactivating of the received configuration for the conditional handover comprises: means configured to perform: maintaining the configuration for the conditional handover.

In an example, the maintaining comprises continuing to store the configuration for the conditional handover.

In an example, the configuration for the measurement event comprises an entering condition, wherein the means are configured to perform: in response to measuring the entering condition of the measurement event being met, providing a further measurement report to the serving cell, the further measurement report indicating that the entering condition of the measurement event has been met.

In an example, the means are configured to perform: in response to measuring the entering condition event being met a further threshold number of times, providing the further measurement report to the serving cell, the further measurement report indicating that the entering condition of the measurement event has been met the further threshold number of times.

In an example, the means are configured to perform: initiating a timer in the terminal.

In an example, the timer is initiated in response to measuring that the entering condition of the measurement event has been met.

In an example, the timer is initiated in response to providing the further measurement report to the serving cell.

In an example, the means are configured to perform: in response to providing the further measurement report, receiving a further message from the serving cell, wherein the further message comprises an indication for the terminal to activate the configuration for the conditional handover; activating the configuration for the conditional handover; and stopping the countdown timer.

In an example, the means are configured to perform: in response to the timer expiring before receiving a further message from the serving cell, activating a further configuration for a further measurement event; and performing measurements on one or more neighbour cells according to the further configuration for the further measurement event.

In an example, the means are configured to perform: receiving the configuration of the further measurement event from the serving cell.

In an example, the measurement event and the further measurement event are different. In an example, the measurement event is an A2 measurement event, and the further measurement event is an A3 measurement event.

In an example, the means are configured to perform: in response to providing the further measurement report, receiving a further message from the serving cell, wherein the further message comprises a further configuration for a conditional handover that is different to the stored configuration for the conditional handover; activating the further configuration for the conditional handover; and stopping the timer.

In an example, the means are configured to perform: replacing the stored configuration for the conditional handover with the further configuration for the conditional handover.

In an example, the configuration for the conditional handover includes a handover execution condition, wherein the means are configured to perform: in response to determining that the execution condition of the conditional handover has been met, initiating a random access procedure with a target cell.

In an example, the message comprises the threshold value.

In an example, the means are configured to perform: receiving the threshold value from the serving cell.

In an example, the measurement event configuration is for an A2 measurement event.

According to an aspect, there is provided an apparatus comprising: one or more processors, and memory storing instructions that, when executed by the one or more processors, cause the apparatus to perform: receiving a message from a serving cell, wherein the message comprises a configuration for a measurement event and a configuration for a conditional handover, the configuration for the measurement event comprising a leaving condition; in response to measuring the leaving condition of the measurement event being met, incrementing a counter; and when it is determined that the counter has reached a threshold value, deactivating the received configuration for the conditional handover and providing a measurement report to the serving cell, the measurement report indicating that the leaving condition of the measurement event has been met.

In an example, the apparatus is caused to perform: activating the received configuration for the conditional handover at the terminal. The activating may be performed before the deactivating. The activating comprising monitoring an execution condition of the conditional handover.

In an example, the threshold value is an integer with a value of two or more.

In an example, the apparatus being caused to perform the deactivating of the received configuration for the conditional handover comprises: maintaining the configuration for the conditional handover.

In an example, the maintaining comprises continuing to store the configuration for the conditional handover.

In an example, the configuration for the measurement event comprises an entering condition, wherein the apparatus is caused to perform: in response to measuring the entering condition of the measurement event being met, providing a further measurement report to the serving cell, the further measurement report indicating that the entering condition of the measurement event has been met.

In an example, the apparatus is caused to perform: in response to measuring the entering condition event being met a further threshold number of times, providing the further measurement report to the serving cell, the further measurement report indicating that the entering condition of the measurement event has been met the further threshold number of times.

In an example, the apparatus is caused to perform: initiating a timer in the terminal.

In an example, the timer is initiated in response to measuring that the entering condition of the measurement event has been met.

In an example, the timer is initiated in response to providing the further measurement report to the serving cell.

In an example, the apparatus is caused to perform: in response to providing the further measurement report, receiving a further message from the serving cell, wherein the further message comprises an indication for the terminal to activate the configuration for the conditional handover; activating the configuration for the conditional handover; and stopping the countdown timer.

In an example, the apparatus is caused to perform: in response to the timer expiring before receiving a further message from the serving cell, activating a further configuration for a further measurement event; and performing measurements on one or more neighbour cells according to the further configuration for the further measurement event.

In an example, the apparatus is caused to perform: receiving the configuration of the further measurement event from the serving cell.

In an example, the measurement event and the further measurement event are different. In an example, the measurement event is an A2 measurement event, and the further measurement event is an A3 measurement event.

In an example, the apparatus is caused to perform: in response to providing the further measurement report, receiving a further message from the serving cell, wherein the further message comprises a further configuration for a conditional handover that is different to the stored configuration for the conditional handover; activating the further configuration for the conditional handover; and stopping the timer.

In an example, the apparatus is caused to perform: replacing the stored configuration for the conditional handover with the further configuration for the conditional handover.

In an example, the configuration for the conditional handover includes a handover execution condition, wherein the apparatus is caused to perform: in response to determining that the execution condition of the conditional handover has been met, initiating a random access procedure with a target cell.

In an example, the message comprises the threshold value.

In an example, the apparatus is caused to perform: receiving the threshold value from the serving cell.

In an example, the measurement event configuration is for an A2 measurement event.

According to an aspect, there is provided an apparatus for a serving cell, the apparatus comprising means configured to perform: providing a message to a terminal, wherein the message comprises a configuration for a measurement event and a configuration for a conditional handover, the configuration for the measurement event comprising a leaving condition; and receiving a measurement report from the terminal, wherein the measurement report indicates that the leaving condition of the measurement event has been met a threshold value number of times at the terminal.

In an example, the means are configured to perform: providing a configuration for the terminal to deactivate the received configuration for the conditional handover when the terminal determines that the leaving condition has been met a threshold value number of times.

In an example, the configuration for the terminal is comprised in the message.

In an example, the means are configured to perform: in response to receiving the measurement report, providing a release message to one or more target cells, the release message indicating for the one or more target cells to release the resources associated with the configuration for the conditional handover.

In an example, the configuration for the measurement event comprises an entering condition, wherein the means are configured to perform: receiving a further measurement report from the terminal, the further measurement report indicating that the entering condition of the measurement event has been met.

In an example, the means are configured to perform: providing a request message to the one or more target cells, the request message requesting that the previously configured, configuration for the conditional handover for the terminal, is activated.

In an example, the means are configured to perform: receiving an acknowledgement message from the one or more target cells, the acknowledgement message indicating that: the configuration for the conditional handover is activated, and the associated resources have been reserved at the one or more target cells.

In an example, the means are configured to perform: in response to receiving the acknowledgement message, providing a further message to the terminal, wherein the further message comprises an indication for the terminal to activate the configuration for the conditional handover.

In an example, the means are configured to perform: receiving a negative acknowledgement message from the one or more target cells, the negative acknowledgement message indicating that the configuration for the conditional handover has not been activated.

In an example, the means are configured to perform: in response to receiving the further measurement report, providing a further message to the terminal, wherein the further message comprises a further configuration for a conditional handover that is different to the stored configuration for the conditional handover.

In an example, the means are configured to perform: providing a further configuration for a further measurement event to the terminal, so to allow the terminal to perform measurements on one or more neighbour cells according to the further configuration for the further measurement event, wherein the further configuration is configured to be activated by the terminal when the configuration for the conditional handover is de-activated by the terminal.

In an example, at least of: the configured for the measurement event is for an A2 measurement event, and the further configuration for the further measurement event is for an A3 measurement event.

According to an aspect, there is provided an apparatus comprising: one or more processors, and memory storing instructions that, when executed by the one or more processors, cause the apparatus to perform: providing a message to a terminal, wherein the message comprises a configuration for a measurement event and a configuration for a conditional handover, the configuration for the measurement event comprising a leaving condition; and receiving a measurement report from the terminal, wherein the measurement report indicates that the leaving condition of the measurement event has been met a threshold value number of times at the terminal.

In an example, the apparatus is caused to perform: providing a configuration for the terminal to deactivate the received configuration for the conditional handover when the terminal determines that the leaving condition has been met a threshold value number of times.

In an example, the configuration for the terminal is comprised in the message.

In an example, the apparatus is caused to perform: in response to receiving the measurement report, providing a release message to one or more target cells, the release message indicating for the one or more target cells to release the resources associated with the configuration for the conditional handover.

In an example, the configuration for the measurement event comprises an entering condition, wherein the apparatus is caused to perform: receiving a further measurement report from the terminal, the further measurement report indicating that the entering condition of the measurement event has been met.

In an example, the apparatus is caused to perform: providing a request message to the one or more target cells, the request message requesting that the previously configured, configuration for the conditional handover for the terminal, is activated.

In an example, the apparatus is caused to perform: receiving an acknowledgement message from the one or more target cells, the acknowledgement message indicating that: the configuration for the conditional handover is activated, and the associated resources have been reserved at the one or more target cells.

In an example, the apparatus is caused to perform: in response to receiving the acknowledgement message, providing a further message to the terminal, wherein the further message comprises an indication for the terminal to activate the configuration for the conditional handover.

In an example, the apparatus is caused to perform: receiving a negative acknowledgement message from the one or more target cells, the negative acknowledgement message indicating that the configuration for the conditional handover has not been activated.

In an example, the apparatus is caused to perform: in response to receiving the further measurement report, providing a further message to the terminal, wherein the further message comprises a further configuration for a conditional handover that is different to the stored configuration for the conditional handover.

In an example, the apparatus is caused to perform: providing a further configuration for a further measurement event to the terminal, so to allow the terminal to perform measurements on one or more neighbour cells according to the further configuration for the further measurement event, wherein the further configuration is configured to be activated by the terminal when the configuration for the conditional handover is de-activated by the terminal.

In an example, at least of: the configured for the measurement event is for an A2 measurement event, and the further configuration for the further measurement event is for an A3 measurement event.

According to an aspect, there is provided a method performed by a terminal, the method comprising: receiving a message from a serving cell, wherein the message comprises a configuration for a measurement event and a configuration for a conditional handover, the configuration for the measurement event comprising a leaving condition; in response to measuring the leaving condition of the measurement event being met, incrementing a counter; and when it is determined that the counter has reached a threshold value, deactivating the received configuration for the conditional handover and providing a measurement report to the serving cell, the measurement report indicating that the leaving condition of the measurement event has been met.

In an example, the method comprises: activating the received configuration for the conditional handover at the terminal. The activating may be performed before the deactivating. The activating comprising monitoring an execution condition of the conditional handover.

In an example, the threshold value is an integer with a value of two or more.

In an example, the deactivating of the received configuration for the conditional handover comprises: maintaining the configuration for the conditional handover.

In an example, the maintaining comprises continuing to store the configuration for the conditional handover.

In an example, the configuration for the measurement event comprises an entering condition, wherein the method comprises: in response to measuring the entering condition of the measurement event being met, providing a further measurement report to the serving cell, the further measurement report indicating that the entering condition of the measurement event has been met.

In an example, the method comprises: in response to measuring the entering condition event being met a further threshold number of times, providing the further measurement report to the serving cell, the further measurement report indicating that the entering condition of the measurement event has been met the further threshold number of times.

In an example, the method comprises: initiating a timer in the terminal.

In an example, the timer is initiated in response to measuring that the entering condition of the measurement event has been met.

In an example, the timer is initiated in response to providing the further measurement report to the serving cell.

In an example, the method comprises: in response to providing the further measurement report, receiving a further message from the serving cell, wherein the further message comprises an indication for the terminal to activate the configuration for the conditional handover; activating the configuration for the conditional handover; and stopping the countdown timer.

In an example, the method comprises: in response to the timer expiring before receiving a further message from the serving cell, activating a further configuration for a further measurement event; and performing measurements on one or more neighbour cells according to the further configuration for the further measurement event.

In an example, the method comprises: receiving the configuration of the further measurement event from the serving cell.

In an example, the measurement event and the further measurement event are different. In an example, the measurement event is an A2 measurement event, and the further measurement event is an A3 measurement event.

In an example, the method comprises: in response to providing the further measurement report, receiving a further message from the serving cell, wherein the further message comprises a further configuration for a conditional handover that is different to the stored configuration for the conditional handover; activating the further configuration for the conditional handover; and stopping the timer.

In an example, the method comprises: replacing the stored configuration for the conditional handover with the further configuration for the conditional handover.

In an example, the configuration for the conditional handover includes a handover execution condition, wherein the method comprises: in response to determining that the execution condition of the conditional handover has been met, initiating a random access procedure with a target cell.

In an example, the message comprises the threshold value.

In an example, the method comprises: receiving the threshold value from the serving cell.

In an example, the measurement event configuration is for an A2 measurement event.

According to an aspect, there is provided a method performed by a serving cell, the method comprising: providing a message to a terminal, wherein the message comprises a configuration for a measurement event and a configuration for a conditional handover, the configuration for the measurement event comprising a leaving condition; and receiving a measurement report from the terminal, wherein the measurement report indicates that the leaving condition of the measurement event has been met a threshold value number of times at the terminal.

In an example, the method comprises: providing a configuration for the terminal to deactivate the received configuration for the conditional handover when the terminal determines that the leaving condition has been met a threshold value number of times.

In an example, the configuration for the terminal is comprised in the message.

In an example, the method comprises: in response to receiving the measurement report, providing a release message to one or more target cells, the release message indicating for the one or more target cells to release the resources associated with the configuration for the conditional handover.

In an example, the configuration for the measurement event comprises an entering condition, wherein the method comprises: receiving a further measurement report from the terminal, the further measurement report indicating that the entering condition of the measurement event has been met.

In an example, the method comprises: providing a request message to the one or more target cells, the request message requesting that the previously configured, configuration for the conditional handover for the terminal, is activated.

In an example, the method comprises: receiving an acknowledgement message from the one or more target cells, the acknowledgement message indicating that: the configuration for the conditional handover is activated, and the associated resources have been reserved at the one or more target cells.

In an example, the method comprises: in response to receiving the acknowledgement message, providing a further message to the terminal, wherein the further message comprises an indication for the terminal to activate the configuration for the conditional handover.

In an example, the method comprises: receiving a negative acknowledgement message from the one or more target cells, the negative acknowledgement message indicating that the configuration for the conditional handover has not been activated.

In an example, the method comprises: in response to receiving the further measurement report, providing a further message to the terminal, wherein the further message comprises a further configuration for a conditional handover that is different to the stored configuration for the conditional handover.

In an example, the method comprises: providing a further configuration for a further measurement event to the terminal, so to allow the terminal to perform measurements on one or more neighbour cells according to the further configuration for the further measurement event, wherein the further configuration is configured to be activated by the terminal when the configuration for the conditional handover is de-activated by the terminal.

In an example, at least of: the configured for the measurement event is for an A2 measurement event, and the further configuration for the further measurement event is for an A3 measurement event.

According to an aspect, there is provided a computer program comprising computer executable instructions which when run on one or more processors perform: receiving a message from a serving cell, wherein the message comprises a configuration for a measurement event and a configuration for a conditional handover, the configuration for the measurement event comprising a leaving condition; in response to measuring the leaving condition of the measurement event being met, incrementing a counter; and when it is determined that the counter has reached a threshold value, deactivating the received configuration for the conditional handover and providing a measurement report to the serving cell, the measurement report indicating that the leaving condition of the measurement event has been met.

According to an aspect, there is provided a computer program comprising computer executable instructions which when run on one or more processors perform: providing a message to a terminal, wherein the message comprises a configuration for a measurement event and a configuration for a conditional handover, the configuration for the measurement event comprising a leaving condition; and receiving a measurement report from the terminal, wherein the measurement report indicates that the leaving condition of the measurement event has been met a threshold value number of times at the terminal

A computer product stored on a medium may cause an apparatus to perform the methods as described herein.

An electronic device may comprise apparatus as described herein.

In the above, various aspects have been described. It should be appreciated that further aspects may be provided by the combination of any two or more of the various aspects described above.

Various other aspects and further embodiments are also described in the following detailed description and in the attached claims.

According to some aspects, there is provided the subject matter of the independent claims. Some further aspects are defined in the dependent claims. The embodiments that do not fall under the scope of the claims are to be interpreted as examples useful for understanding the disclosure.

### List of Abbreviations

AF: Application Function
AMF: Access Management Function
AN Access Network
BS: Base Station
CFRA: Contention-free Random Access
CHO: Conditional Handover
CN: Core Network
DL Downlink
eNB: eNodeB
gNB: gNodeB
IIoT: Industrial Internet of Things
LTE: Long Term Evolution
NEF: Network Exposure Function
NG-RAN: Next Generation Radio Access Network
NF: Network Function
NR: New Radio
NRF: Network Repository Function
NW: Network
MR: Measurement Report
MS: Mobile Station
PCF Policy Control Function
PLMN: Public Land Mobile Network
RA Random Access
RAN: Radio Access Network
RedCap: Reduced Capability
RF: Radio Frequency
RRC: Radio Resource Control
SMF: Session Management Function
SSB: Synchronisation Signal Block
UE: User Equipment
UDR: Unified Data Repository
UDM: Unified Data Management
UL: Uplink
UPF: User Plane Function
3GPP: 3^{rd} Generation Partnership Project
5G: 5^{th} Generation
5GC: 5G Core network
5G-AN: 5G Radio Access Network
5GS: 5G System

### DESCRIPTION OF FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4 shows a schematic representation of terminals locations at cell edges;

FIG. 5 shows an example signalling diagram between network entities for a conditional handover;

FIG. 6 shows a graphical representation of serving cell measurements performed by a terminal;

FIG. 7 shows an example signalling diagram between network entities for a conditional handover with an optimised number of measurement reports;

FIGS. 8a and 8b show another example signalling diagram between network entities for a conditional handover with an optimised number of measurement reports;

FIG. 9 shows a graphical representation of a terminal measuring the entering and leaving of an A2 event;

FIG. 10 shows an example method flow diagram performed by a terminal;

FIG. 11 shows another example method flow diagram performed by a network node; and

FIG. 12 shows a schematic representation of a non-volatile memory medium storing instructions which when executed by a processor allow a processor to perform one or more of the steps of the method of FIGS. 10 and 11.

### DETAILED DESCRIPTION

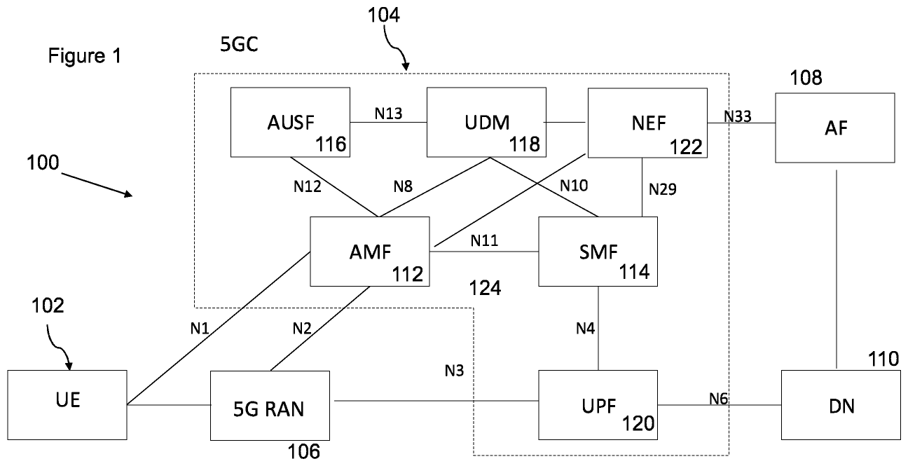

Before explaining in detail some examples of the present disclosure, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices/terminals or user apparatuses, and/or user equipments (UE), and/or machine-type communication devices 102 are provided wireless access via at least one base station (not shown) or similar wireless transmitting and/or receiving node or point. A communication device is provided with an appropriate signal receiving and transmitting apparatus for enabling communications, for example enabling access to a communication network or communications directly with other devices. The communication device may access a carrier provided by a base station or access point, and transmit and/or receive communications on the carrier.

In the following certain examples are explained with reference to mobile communication devices capable of communication via a wireless cellular system and mobile communication systems serving such mobile communication devices. Before explaining in detail, the examples of disclose, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS) 100. The 5GS may comprises a device 102 such as user equipment or terminal, a 5G access network (5G-AN) 106, a 5G core network (5GC) 104, one or more network functions (NF), one or more application function (AF) 108 and one or more data networks (DN) 110.

The 5G-AN 106 may comprise one or more gNodeB (gNB) distributed unit functions connected to one or more gNodeB (gNB) centralized unit functions.

The 5GC 104 may comprise an access management function (AMF) 112, a session management function (SMF) 114, an authentication server function (AUSF) 116, a user data management (UDM) 118, a user plane function (UPF) 120, a network exposure function (NEF) 122 and/or other NFs. Some of the examples as shown below may be applicable to 3GPP 5G standards. However, some examples may also be applicable to 4G, 3G and other 3GPP standards.

In a communication system, such as that shown in FIG. 1, mobile communication devices/terminals or user apparatuses, and/or user equipments (UE), and/or machine-type communication devices are provided with wireless access via at least one base station or similar wireless transmitting and/or receiving node or point. The terminal is provided with an appropriate signal receiving and transmitting apparatus for enabling communications, for example enabling access to a communication network or communications directly with other devices. The communication device may access a carrier provided by a station or access point, and transmit and/or receive communications on the carrier.

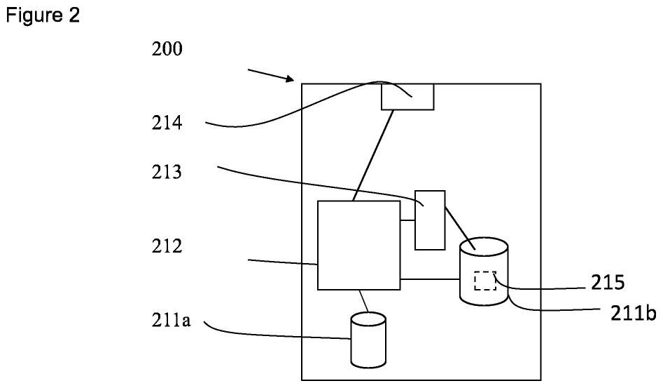

FIG. 2 illustrates an example of a control apparatus 200 for controlling a function of the 5G-AN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G-AN or the 5GC. In some examples, each function of the 5G-AN or the 5GC comprises a control apparatus 200. In alternative examples, two or more functions of the 5G-AN or the 5GC may share a control apparatus.

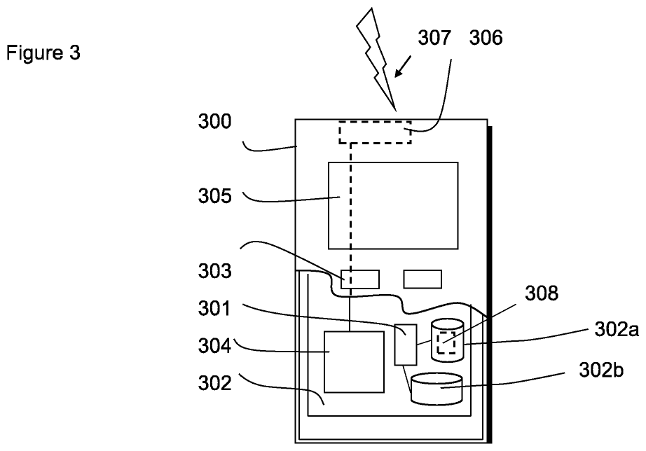

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302a and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus may be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

Some of the following examples are relevant to terminals, such as UEs and reduced capability (RedCap) devices. RedCap devices are a device type in 5G that have a reduced capability. The introduction of the RedCap devices takes its motivation from providing a cheaper alternative handset/device that supports a subset of the NR/5G capabilities. In some examples, some of the factors of the RedCap devices are, for example: a reduced number of Tx/Rx antennas, a reduced bandwidth, cheap, and a low energy consumption. At the same time, some of the RedCap devices may to save energy while they come with certain latency guarantees with service availability as stated in, for example, TS 22.104 and TR 38.875.

Some example use cases have been identified for RedCap devices, such as:

1. Industrial wireless sensors: Communication service availability is 99.99% and end-to-end latency less than 100 ms. The reference bit rate is less than 2 Mbps (potentially asymmetric e.g. UL heavy traffic) for all use cases and the device is stationary. The battery should last at least few years. For safety related sensors, the latency requirement is lower, 5-10 ms.

2. Video Surveillance: As described in TR 22.804, reference economic video bitrate would be 2-4 Mbps, latency <500 ms, reliability 99%-99.9%. High-end video e.g. for farming would require 7.5-25 Mbps. It is noted that the traffic pattern is dominated by UL transmissions.

3. Wearables: Reference bitrate for smart wearable application can be 5-50 Mbps in DL and 2-5 Mbps in UL and peak bit rate of the device higher, up to 150 Mbps for downlink and up to 50 Mbps for uplink. The battery of the device should last multiple days (up to 1-2 weeks).

In wireless networks, a UE may perform received signal measurements periodically or non-periodically, depending on the use case or scenario. Those measurements will use energy on the UE side and drain the battery (if battery operated). Optimizing energy consumption of UEs through reduced measurement frequency can be investigated in two branches. The first branch is mobility-related measurements and the second is user plane-related measurements. Radio Resource Management (RRM) relaxation investigates purely mobility-related measurements. RRM relaxation is composed of two components: i) a RRM relaxation trigger, and ii) a RRM measurement relaxation.

The RRM relaxation trigger is a criterion, either configured to the UE or acquired by the UE from the serving cell. This criterion is used to initiate RRM measurement relaxation. There has been specified two types of RRM relaxation triggers for the UE, i) low mobility criteria, and ii) cell edge criteria.

For the ‘Low mobility criteria’, this criterion aims to identify a UE at a low mobility state. A reference signal received power (RSRP) of the serving cell, ‘RSRPrx’, should meet within a period of TSearchDeltaP with the following criteria, as in equation (1) below:

(RSRPrxRef−RSRPrx)<RSRPSearchDeltaP (1)

‘RSRPrx’ is the current RSRP of the serving gNB. ‘RSRPrxRef’ is a reference value RSRP value that is updated in three different ways. Firstly, it is updated to the RSRP value of the serving gNB after selecting or reselecting a new gNB. Secondly, it is updated to the new RSRP value, when UE is moving closer to the cell center i.e., (RSRPrx−RSRPrxRef)>0. Thirdly, if the relaxed measurement criterion has not been met for TSearchDeltaP, the UE shall set the value of RSRPrxRef to the current RSRPrx value. Finally, ‘RSRPSearchDeltaP’ is a parameter configured UE to monitor the received signal variation.

For the ‘Cell edge criteria’, this criterion aims to detect if UE is not at the cell edge. A UE compares the received signal level versus a threshold as in equation (2) below:

RSRPrx>RSRPSearchThresholdP (2)

‘RSRPSearchThresholdP’ is the RSRP threshold set for this criterion.

A UE can be configured to monitor at least one of the RRM relaxation triggers. The network can configure the trigger to the UE independently. For example, the UE can be configured with either low-mobility, or not-at-cell-edge, or both. In a case wherein the RRM relaxation is triggered with respect to its configuration, the UE will apply RRM measurement relaxation.

For RRM measurement relaxation, there are multiple ways to relax measurements. For example, for the cell that the measurements are to be relaxed, it may be determined how frequent the measurements should be made. For example, reducing the periodicity of the measurements for the relaxed cell. The cell that the measurements are to be relaxed may be a neighbour cell or a serving cell for example. Relaxed measurements with longer intervals (scaling factor) may be configured for terminals/UEs/RedCap devices. For instance, a UE can stop measurements for up to 1 hour. This number is given as an example only, in other examples the measurements could be stopped for more or less than 1 hour.

It has been proposed that the RRM relaxation framework may be extended for use by RedCap devices. The framework may consider a new relaxation trigger, for example, a determination that a device is stationary, instead of a low mobility.

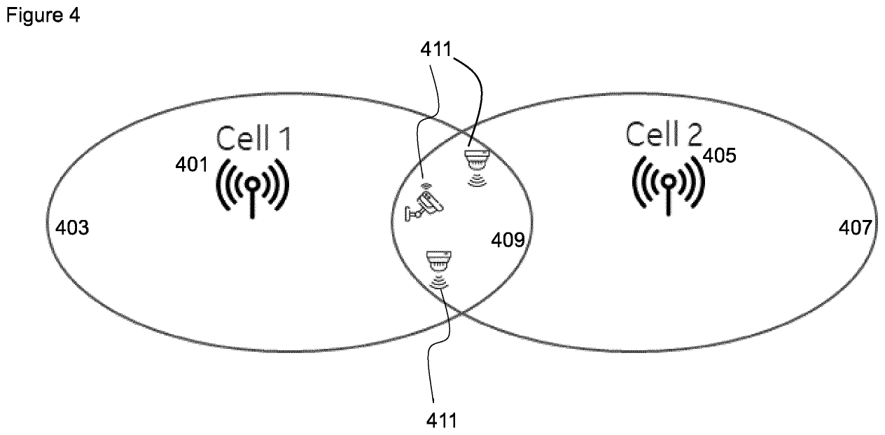

FIG. 4 shows a schematic representation of terminals locations at cell edges. FIG. 4 shows a first cell (cell 1) 401 which has a first cell area 403. There is also provided a second cell (cell 2) 405 which has a second cell area 407. The first cell area 403 and second cell area 407 overlap one another (overlap area 409). A plurality of devices 411 are located within the overlap area 409. The plurality of devices 411 may be RedCap devices.

Even though the devices may be stationary, some of the devices will be placed on the cell edge. With dynamic coverage due to mobility in the environment and changing weather conditions, the devices may need to change the cell they are connected to (handover). Devices such as, for example, security cameras, alarms, and motion sensor may remain stationary for the majority of their lifetime. These types of devices may be RedCap devices.

It has identified that cell edge RedCap devices may not be able to perform RRM relaxation even though they are stationary devices. These device will have to go through a normal mobility procedure including the provision of a high number of measurement reports. This can lead to a reduction of battery life in devices.

In some known systems, one way to avoid frequent measurement reporting by UEs is to configure the UEs for conditional handover (CHO) to the UE. A CHO may be defined as a handover that is executed by a UE when one or more handover execution conditions are met. The UE starts evaluating the one or more execution conditions upon receiving the CHO configuration, and stops evaluating the one or more execution conditions once a handover is executed or the CHO configuration is terminated/removed.

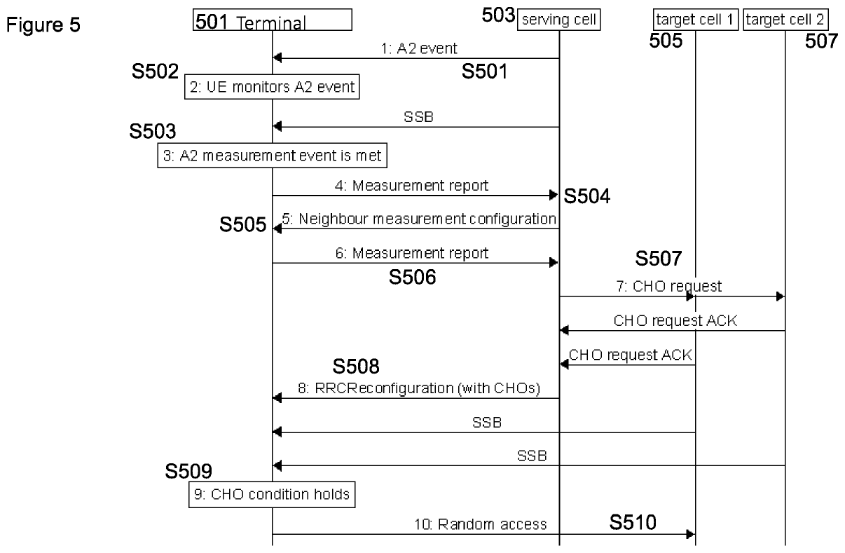

FIG. 5 shows an example signalling diagram between network entities for a conditional handover. Communications are between a terminal 501, a serving cell 503, a target cell 1 505, and a target cell 2 507. To be able to determine when a CHO can be configured, a UE will be configured with an A2 measurement event, as shown in S501. In S502, the UE monitors the A2 event, and the UE sends the measurement report when the entering condition of the A2 event is met (S503/S504). An A2 event occurs when a radio measurement of the serving cell becomes worse than a threshold value. The UE may send a measurement report each time the A2 measurement event is met (S503/S504). The serving cell configures the UE to start measuring the received signals of a neighbour cell in S505. After the neighbour measurements reports are received by the serving cell, in S506, the serving cell can configure the UE with CHO, in S507. The S507 includes providing a CHO request to target cells (1 and 2) and receiving an ACK from the target cells, accepting the request. In S508, the serving cell provides the CHO configuration within an RRCReconfiguration message. The UE will then monitor the condition of the CHO configuration. In S509, the condition is met. In S510, the UE starts a random access procedure with the target cell.

The procedure of FIG. 5 only enables the UE to stop sending measurement reports (of steps S504 and S506) after step S508 has been completed. An issue identified is that CHO requires resources reservations at all target cells in terms of contention-free random access (CFRA) preambles and radio resources that are needed to serve the UE when it executes CHO. Thus, CHO reservations should not be kept for a long time if they are not needed anymore. Otherwise, the target cell(s) will experience inefficient/long resource reservation.

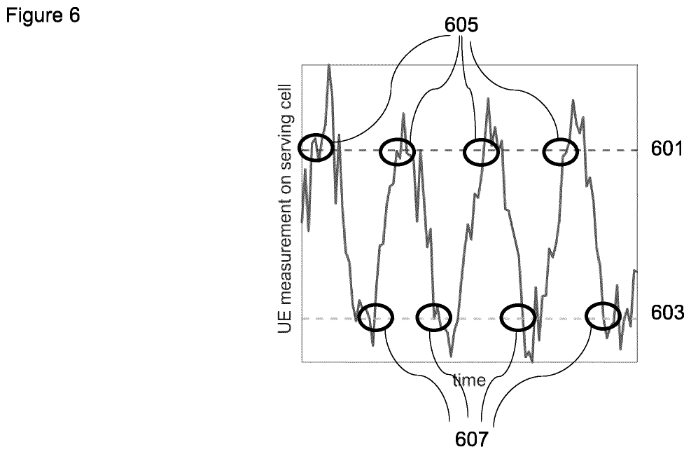

In other known systems, a UE may be configured to report to the serving cell (measurement report) when a leaving condition of the A2 event is met, i.e., the radio measurement of the serving cell becomes higher than a threshold. FIG. 6 shows a graphical representation of serving cell measurements performed by a terminal. FIG. 6 shows a first threshold value 601 and a second threshold value 603, wherein the second threshold value is lower than the first. When a measurement of the serving cell is measured by the UE to be above the first threshold value 601 then this represents an A2 leave condition. When a measurement of the serving cell is measured below the second threshold value 603 then this represents an A2 enter condition. In FIG. 6, the circles labelled 605 represent A2 leave conditions, and the circles labelled 607 represent A2 enter conditions.

Once a measurement report is provided to the serving cell, this may trigger the serving cell to release the CHO resource reservations as they are no longer needed. This is because the UE has measured that the connection to the serving cell is stronger than the threshold, meaning that the radio measurement of the serving cell is good enough to serve the UE. For this to occur, the UE will send an RRC Measurement report, and the serving cell will send an additional signalling message (RRCReconfiguration) to the UE for releasing the CHO preparations. In other examples, the network may not release the CHO configuration and UE may continue to report the A2 measurement report on the leave condition 605.

Depending on the changes in the radio conditions, the entering condition of the measurement event A2 may be met multiple times within a specific time duration, as seen in FIG. 6 (607). In some situations, the network can make A2 leave condition more difficult. For example, by increasing the A2 threshold of leave condition. This would prevent UEs from meeting the A2 leave condition frequently (leading to less reporting). However, increasing the A2 threshold of leave condition risks other UEs in the network, that do not have fluctuating measurements, being prevented from reporting the measurement report on leave, in order to prevent long CHO reservations.

Some of the following examples aim to address one or more of the problems identified above. In some examples, there is provided a mechanism wherein a terminal/UE receives from a network, a CHO configuration, the CHO configuration having an execution condition. The terminal is configured to evaluate the execution condition of the CHO configuration once a measurement event entering condition has been met, but stop the evaluation of the execution condition of the CHO configuration when a leaving condition of the measurement event is met. At the network side, the CHO configuration provided to the terminal can be stored by the network. The re-activation of the stored CHO configurations is then enabled by preparing the same CHO, as the previously stored CHO configuration, whenever possible in order to minimise resource usage. In this way, there is provided a CHO configuration release procedure that is energy efficient for terminals, such as RedCap devices, and resource efficient for the network.

In some examples, in order to reduce the terminal's power consumption, a counter is proposed for the measurement event such that the counter is incremented each time the leaving condition is met. The terminal will then send the measurement report to the network only when the leaving condition of the measurement event is met a predetermined number of times. As such, a trade-off can be achieved between reducing CHO resource reservation (which is released when the measurement report is received at the network) and minimizing the terminal's power consumption.

For the network, the serving base station is able to control the CHO reservation period with an introduced parameter ‘x’ which determines how many times the leaving condition will be met before the measurement report is sent by the terminal. The serving base station may set the value of ‘x’ to 1 to be able to release CHO reservation immediately each time the leaving condition of the measurement event is met. Alternatively, the serving base station may set the value of ‘x’ to a value greater than 1 for a longer CHO reservation period, which enables the terminal to save power.

In some examples, the serving base station may not need to signal to the terminal for releasing the CHO configurations as the terminals are configured to de-activate the CHO configuration autonomously when the leaving condition of the measurement event is met.

For the terminal side, the terminal may de-activate the CHO configuration when a leaving condition of the measurement event is met, without the need to receive RRC-reconfiguration messages. The receiving of the messages from the network causes draining of the terminal's battery (increased power consumption). In examples, the terminal may activate the CHO with a message received from the network. In examples, the message may be similar to an RRC reconfiguration message, but with fewer bits compared to a typical RRCReconfiguration message. In examples, the message may be a medium access control control element (MAC CE) message.

In some examples, the terminal sends a measurement report when the leaving condition of measurement event is met if the leaving condition is met a predetermined number of times. This may reduce the number of measurement reports that are signalled to the network. This may, in turn, reduce the terminal power consumption.

This will be discussed in more detail below.

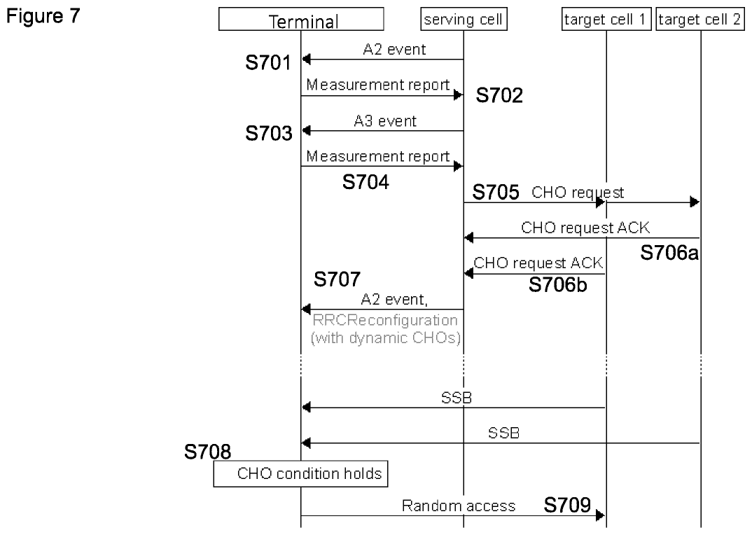

FIG. 7 shows an example signalling diagram between network entities for a conditional handover with an optimised number of measurement reports.

In S701, the serving cell provides a configuration for a measurement event to the terminal. In this example, the measurement event is an A2 event. In other examples, other suitable measurement events are configured at the terminal. An A2 event is when the serving becomes worse than a threshold. In response to receiving the configuration, the terminal performs measurements on the serving cell.

In S702, when the terminal determines that the measurement of the serving cell falls below the threshold, the terminal provides a measurement report to the serving cell.

In S703, the serving cell provides another configuration for a further measurement event to the terminal. In this example, the measurement event is an A3 event. In other examples, other suitable measurement events are configured at the terminal. An A3 event A3 is when a neighbour becomes an offset better than the serving cell.

In S704, when the terminal determines that the measurement of a neighbour cell becomes an offset amount more than the serving cell, the terminal provides a further measurement report to the serving cell.

In S705, the serving cell requests a CHO configuration preparation from a first and a second target cell, which can be determined from the received measurement reports. For example, the measurement reports indicate that the neighbour cells are more suitable for the terminal, and that a handover may be suitable.

In S706a, the second target cell provides an acknowledgement message to the serving cell.

In S706b, the first target cell provides an acknowledgement message to the serving cell.

In S707, the serving cell provides, along with an A2 event measurement configuration, a CHO configuration to the terminal. The CHO configuration being a dynamic configuration.

The CHO configuration (dynamic CHO) is a CHO that may be activated/de-activated with a signalling mechanism that uses fewer resources than re-configuring the CHO. The CHO may be activated/de-activated with, for example, lower layer signalling.

The terminal will de-activate the CHO configurations when the leaving condition of the A2 measurement event is met. When the CHO configuration is de-activated, the terminal will stop evaluating the execution condition of the CHO. Even though the CHO configuration is de-activated at the terminal, the terminal may store the configuration for future use.

The network may release the CHO configuration upon receiving a measurement report indicating that the leaving condition of A2 measurement event is met.

When the entry condition of the A2 measurement event is met again, the terminal provides a measurement report to the serving cell. In response to this, the network may prepare the same CHO configuration that was de-activated at the terminal and send a message to the terminal to activate the stored CHO configuration.

In another example, the terminal is configured to send a measurement report to the serving cell when the entering condition of the measurement event A2 is met for the first time. However, the terminal will not send a further measurement report when the entering condition of A2 event is met again, unless the terminal has previously reported when the leaving condition of the A2 measurement event is met. For example, when the A2 event is entered the terminal will report to the network. When the A2 event is entered again, the terminal will not report to the network. Alternatively, when the A2 event is entered the terminal will report to the network. The terminal then determines an A2 event leaving condition. Following this, when the terminal determines a subsequent A2 event entering condition, the terminal provides a further report to the network.

In another example, the terminal is configured to send a measurement report when the leaving condition for the A2 event is met a predetermined number, ‘x’, of times. The value ‘x’ may optimise terminal energy consumption but also to decrease CHO reservation time. For example, using x=1, would lead to minimal CHO reservation time at the network. Alternatively, x=∞ would lead to minimal terminal energy consumption by foregoing the transmission of measurement reports to the network, at the expense of reserving indefinitely the CHO resource at the network. Other values of ‘x’ would achieve a trade-off between CHO resource reservation at the network and power consumption at the terminal.

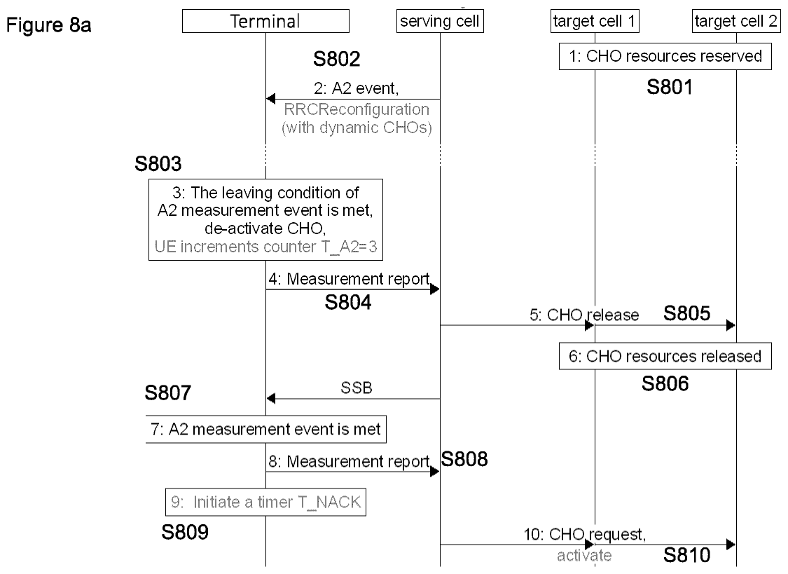

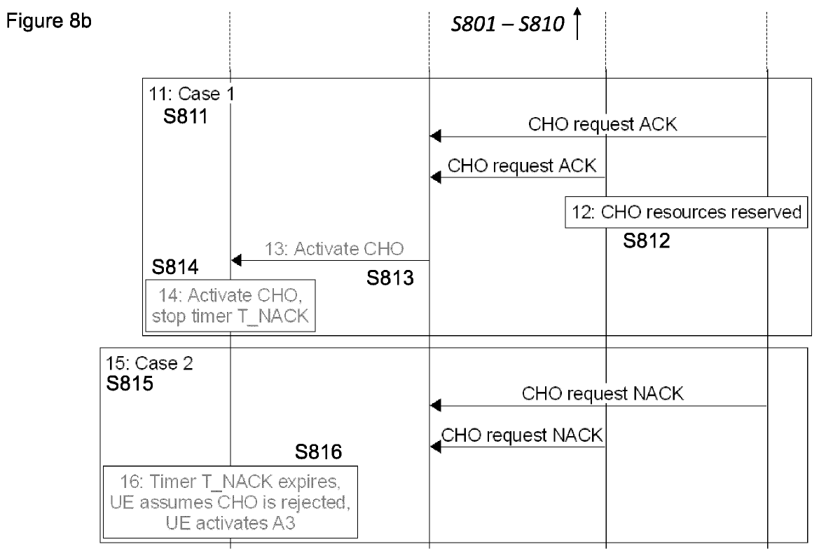

In some examples, the terminal is configured with a timer, ‘T_NACK’. The timer may be used by the terminal to determine how long the de-activated CHO configuration is to be used for. For example, the terminal is configured with an A3 event to be monitored if the timer ‘T_NACK’ expires. This will be discussed in more detail below alongside FIG. 8. The terminal may be configured with the timer in, for example, Msg 2 of a random access procedure, or via a pre-configuration.

In S708, the terminal is monitoring the execution condition of the CHO configuration. The terminal may be monitoring the execution condition of the CHO configuration as the A2 event entering condition has been met. When the leaving condition of the A2 event has been met, the terminal would no longer monitor the CHO execution condition.

When the terminal determines that the execution condition of the CHO configuration is met, the terminal initiates a handover procedure.

In S709, the terminal starts a random access (RA) procedure with the first target cell. In other examples, the terminal starts an RA procedure with the second target cell.

FIGS. 8a and 8b shows another example signalling diagram between network entities for a conditional handover with an optimised number of measurement reports. The steps of FIG. 8b follow on from the steps of FIG. 8a.

In S801, the network reserves resources for a possible handover for the terminal. The handover is a conditional handover. In S801, the network resources are reserved at target cell 1 and target cell 2. In other examples, more or less than two target cells may reserve network resources.

In other examples, the handover is a L1 mobility procedure. As part of the L1 mobility procedure the terminal may be provided with the target cell configuration before a handover, called ‘preparation’. The target cell for which the configuration is provided for is called the ‘prepared cell’. As in the conditional handover case, the network reserves resources for the prepared cell.

In S802, the serving cell provides a message to the terminal. The message comprises a configuration for a measurement event and a CHO configuration. In this example, the measurement event is an A2 event. In other examples, other suitable measurement events are used. The information may be provided in an RRCReconfiguration message.

In S802, the serving cell (network) configures the terminal so that the terminal will de-activate the CHO configuration when a leaving condition of the CHO configuration is met a certain number of times. This configuration for the terminal may be provides as part of the message of S802. In other examples, the configuration is provided with other signalling/transmissions from the network.

The measurement event may have a leaving event threshold and an entering event threshold. The CHO configuration may have an execution condition.

In S803, the terminal performs measurements on the serving cell.

Every time that the terminal measures that the leaving condition of the A2 event is met, the terminal will increment a counter (T_A2). For example, the counter will start at 0, and each time the leaving condition is met, the counter is incremented by 1. This is given as an example only, to aid in the understanding. In other examples, other suitable configurations for the counter are used.

The terminal is configured to provide a measurement report to the serving cell when the counter reaches a certain value, ‘x’. Furthermore, when the terminal measures that the leaving condition of the A2 event is met ‘x’ times, the terminal will de-activate the received CHO configuration. Even though the CHO configuration is de-activated, the terminal may continue to store the CHO configuration. In examples, de-activating the CHO configuration means that the execution condition of the CHO is no longer monitored by the terminal.

In FIG. 8a the value of ‘x’ is 3. It should be understood that this is an example only, in other examples the value of ‘x’ may be higher or lower than 3. The terminal may be pre-configured with the value of ‘x’ for the counter. In other examples, the terminal may receive signalling from the network with the value of ‘x’ for the counter.

In S804, the leaving condition of the A2 event is met for the third time (the counter reaches 3). In response to the counter reaching 3, the terminal provides a measurement report to the serving cell. The measurement report will comprise information that the leaving condition of the A2 event has been met. An A2 event leaving condition means that the serving cell is no longer unsuitable for the terminal.

In S805, the serving cell provides a CHO release message to the target cell 1 and target cell 2.

In S806, in response to receiving the release message, target cells 1 and 2 release the network resources associated with the CHO configuration. The target cells 1 and 2 may continue to store the CHO configuration following the release of the network resources.

Following the provision of the CHO release message, the serving cell may provide one or more synchronisation signal blocks (SSB) to the terminal. The network may provide SSBs to the terminal periodically. The terminal uses to the SSBs to perform the measurements on the serving and neighbour cells for the measurement reports.

In S807, the terminal continues to perform measurements on the serving cell. The terminal determines that the entering condition of the A2 event has been met. The entering of the A2 event means that the serving cell measurement has fallen below a threshold value.

In S808, the terminal provides a further measurement report to the serving cell. The further measurement report indicates that the A2 event has been met (entering condition).

In some examples, similar to S803, the terminal provides the further measurement report to the serving cell once the entering condition has been met a threshold number of times. For example, the terminal will only provide the further measurement report once the entering condition has been met 3 times. In other examples, the value may be more, or less, than 3.

In S809, the terminal initiates a timer. The timer is labelled, ‘T_NACK’. The timer is initiated in response to the further measurement report being provide to the serving cell. In other examples, the terminal initiates the timer in response to measuring that the A2 event entering condition is met. The timer, T_NACK, may be a countdown timer, i.e. counts down from a specific time value. In other examples, the timer may be a count up timer, i.e. counts up to specific value.

In S810, the serving cell provides a CHO request message to the target cells 1 and 2. The request message comprises a request to activate the stored CHO configuration that was previously used. In other examples, the request message comprises a request to reconfigure the stored CHO configuration that was previously used. The message in S810 may be smaller/shorter than a completely new CHO configuration/RRC reconfiguration message.

In S811, this comprises S812, S813 and S814, which form a so-called ‘Case 1’.

In S812, the target cell 1 and 2 reserve the CHO resources for the previously used CHO configuration. Target cell 1 and 3 provide acknowledgement messages to the serving cell. The acknowledgement (ACK) message indicates that the target cells 1 and 2 accept the request from the serving cell to activate the stored CHO configuration. In other examples, one of the target cells 1 and 2 will provide an ACK to the serving cell.

In S813, the serving cell provides an indication to the terminal to activate the stored CHO configuration. This option is available as the target cell 1 and 2 have acknowledged the request to re-activate the previously used CHO configuration. In other examples, the indication may be provided in an RRCReconfiguration message.

In S814, the terminal receives the indication to activate the CHO configuration. By activating the CHO configuration, the terminal will start to evaluate the CHO execution condition. In response to receiving the indication, the terminal stops the timer, T_NACK.

In S815, this comprises S816, which forms a so-called ‘Case 2’.

In S815, the target cells 1 and 2 do not reserve the resources according to the request from the serving request, in S810. The target cells 1 and 2 provide a negative acknowledgement (NACK) message to the serving cell.

In S816, then the timer, T_NACK, of the terminal expires the terminal assumes that the CHO configuration has been rejected by the network. In response to the timer expiring, the terminal begins to perform measurements for neighbour cells, according to an A3 measurement event configuration. The A3 measurement event reporting configuration may be provided beforehand by the serving cell. In case 2, S815, the terminal does not receive signalling from the serving cell activating the CHO configuration.

In in a third case (not shown in FIG. 8), the CHO request is ACK'd by the target cell 1 and/or 2. The ACK comprises a further CHO configuration which is different from the CHO configuration that is stored at the network/de-activated at the terminal side. The terminal then receives a message from the serving cell containing the further CHO configuration to replace the existing configuration. In response to receiving the message from the serving cell, the terminal stops the timer, T_TNACK. In response, the terminal will use the further CHO configuration and monitor the execution condition of the further CHO configuration.

In the example of FIGS. 8a and 8b, a terminal performs the steps on the device-side. In other examples, the device side entity may be a user equipment, RedCap device, or machine-to-machine device.

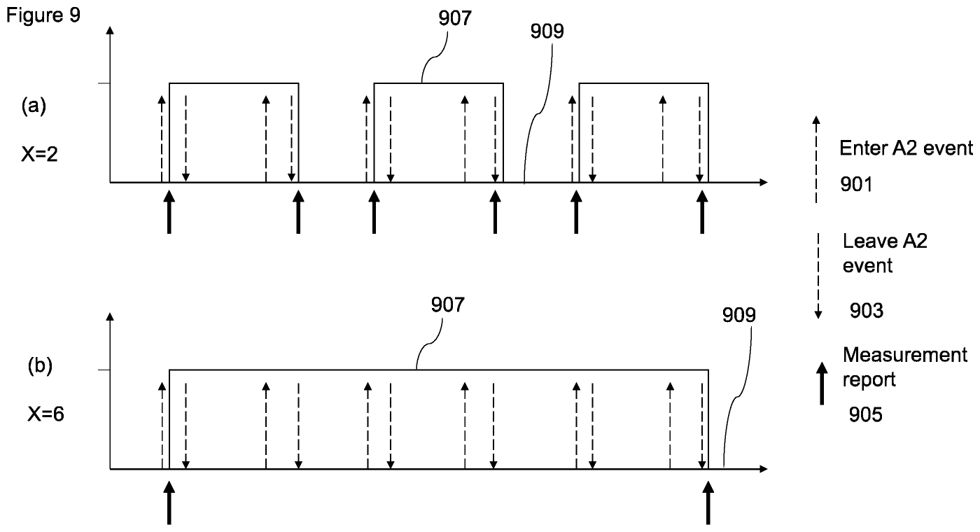

FIG. 9 shows a graphical representation of a terminal measuring the entering and leaving of an A2 event. FIG. 9 illustrates a trade-off realised with the introduction of the parameter “x” as discussed above. The trade-off is related to signalling of the A2 measurement report by the terminal on the leave condition, versus CHO resource reservation at the network.

FIG. 9a illustrates an example whereby the configuration to provide measurement reports from the terminal includes ‘x’ as 2. An arrow 901 directed vertically up indicates a measurement of an A2 enter event. An arrow 903 directed vertically down indicates a measurement of an A2 leave event. Following the measurement of two A2 event leave conditions, the terminal provides a measurement report to the network. This is represented by a bold arrow 905. As seen in FIG. 9a, the line of the graph indicates whether the CHO resources are reserved at the network. When the line is high 907, this indicates that the resources are currently reserved. When the line is low 909, this indicates that the resources are not reserved. In the example time period used in FIG. 9b, the terminal transmits 6 measurement reports to the network.

FIG. 9b illustrates an example whereby the configuration to provide measurement reports from the terminal includes ‘x’ as 6. Following the measurement of six A2 event leave conditions, the terminal provides a measurement report to the network. This is represented by a bold arrow 905. During the same time period as in FIG. 9a, in FIG. 9b, two measurement reports are transmitted by the terminal (compared to 6). However, during this time period, the CHO resources are reserved by the network.

Therefore, the value of ‘x’ will affect how many measurement reports are sent and how long the CHO resources are reserved at the network. The number of measurement reports, and the length of reservation are inversely proportional to one another. The network and/or the terminal may determine an optimal value for ‘x’ depending on a variety of factors.

In an example, ‘x’ may be determined by the network based on current network conditions. In another example, ‘x’ may be determined by the terminal/device based on requirements of the terminal/device. In some examples, the value of ‘x’ may be updated by the network as necessary. The value of ‘x’ may dynamically change as necessary. In another example, the value of ‘x’ is preconfigured for each terminal/device. In another example, the network provides the value of ‘x’ dependent on the device type and/or a mobility level of the device.

For example, when the network has too many resources the network may reserve resources and set the ‘x’ value to infinity (or a high number). when the resources become low, the network may start decreasing the value of ‘x, via a configuring of the terminal. In this way, the value of ‘x’ is updated dynamically.

One or more of the examples discussed above have the advantages that the procedures would save energy on the device side, as the measurement report sent by a terminal that triggers the preparation of the CHO configurations at the network does not need to be sent as frequently. Transmitting fewer measurement reports will mean that less power will be used at the device. Furthermore, the evaluation of the CHO configurations can be de-activated/activated at the device without the need for RRC related reconfigurations to be received at the device. Receiving radio communications at the device will also use power. Therefore, the procedure without the need for the RRC related reconfigurations uses less power (saving battery life).

One or more of the examples discussed above also have the advantage that the network would save radio access network (RAN) load for radio link monitoring (RLM) and mobility procedures thanks to reduced measurement reporting by the terminal. Furthermore, the CHO resources are reserved for less time at the network unnecessarily meaning that resources are used more efficiently.

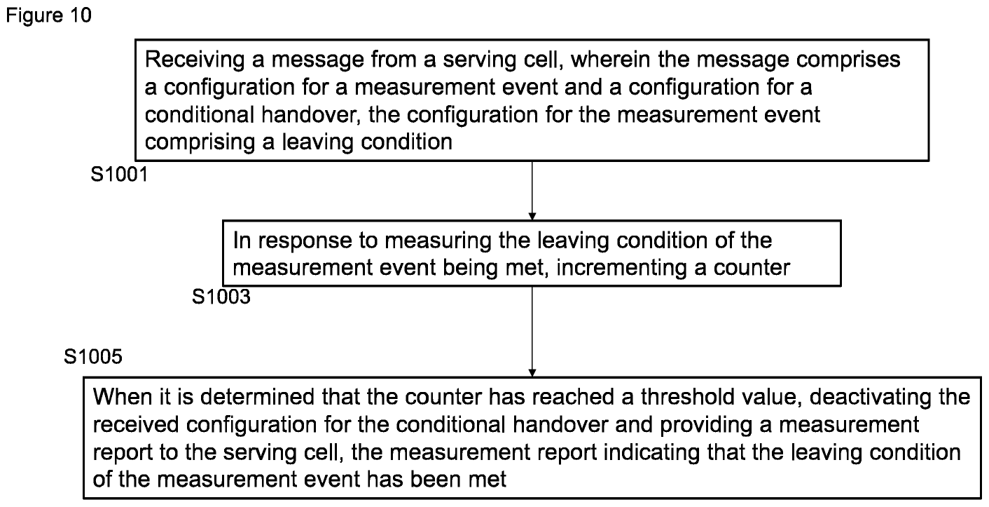

FIG. 10 shows an example method flow performed by an apparatus. The apparatus may be comprised within a terminal. In an example, the terminal may be a user device, such as a UE

In S1001, the method comprises: receiving a message from a serving cell, wherein the message comprises a configuration for a measurement event and a configuration for a conditional handover, the configuration for the measurement event comprising a leaving condition.

In S1003, the method comprises: in response to measuring the leaving condition of the measurement event being met, incrementing a counter.

In S1005, the method comprises: when it is determined that the counter has reached a threshold value, deactivating the received configuration for the conditional handover and providing a measurement report to the serving cell, the measurement report indicating that the leaving condition of the measurement event has been met

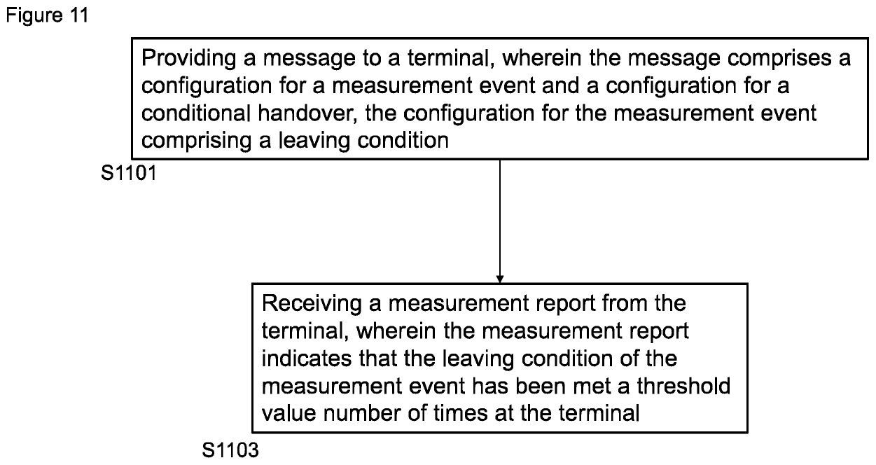

FIG. 11 shows an example method flow performed by an apparatus. The apparatus may be comprised in an entity of a serving cell. The apparatus may be comprised within a network node. In an example, the network node may be a base station, such as a gNB.

In S1101, the method comprises: providing a message to a terminal, wherein the message comprises a configuration for a measurement event and a configuration for a conditional handover, the configuration for the measurement event comprising a leaving condition; and

In S1103, the method comprises: receiving a measurement report from the terminal, wherein the measurement report indicates that the leaving condition of the measurement event has been met a threshold value number of times at the terminal

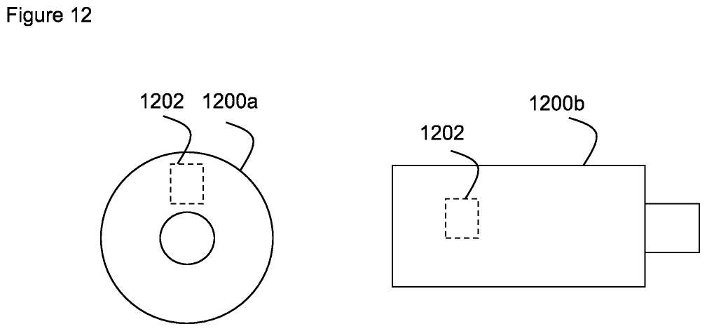

FIG. 12 shows a schematic representation of non-volatile memory media 1200a (e.g. computer disc (CD) or digital versatile disc (DVD)) and 1200b (e.g. universal serial bus (USB) memory stick) storing instructions and/or parameters 1202 which when executed by a processor allow the processor to perform one or more of the steps of the methods of FIG. 10 or FIG. 11.

It is noted that while the above describes example embodiments, there are several variations and modifications which may be made to the disclosed solution without departing from the scope of the present invention.

The examples may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

Alternatively, or additionally some examples may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus for a terminal, the apparatus comprising—: one or more processors, and memory storing instructions that, when executed by the one or more processors, cause the apparatus to perform:
receiving a message from a serving cell, wherein the message comprises a configuration for a measurement event and a configuration for a conditional handover, the configuration for the measurement event comprising a leaving condition;
in response to measuring the leaving condition of the measurement event being met, incrementing a counter; and
when it is determined that the counter has reached a threshold value, deactivating the received configuration for the conditional handover and providing a measurement report to the serving cell, the measurement report indicating that the leaving condition of the measurement event has been met the threshold value number of times.

2. The apparatus according to claim 1, wherein the deactivating of the received configuration for the conditional handover comprises:
maintaining the configuration for the conditional handover.

3. The apparatus according to claim 1, wherein the configuration for the measurement event comprises an entering condition, wherein the apparatus is configured to perform:
in response to measuring the entering condition of the measurement event being met, providing a further measurement report to the serving cell, the further measurement report indicating that the entering condition of the measurement event has been met.

4. The apparatus according to claim 3, configured to perform:
initiating a timer in the terminal.

5. The apparatus according to claim 3, configured to perform:
initiating a timer in the terminal; and
wherein the timer is initiated in response to measuring that the entering condition of the measurement event has been met.

6. The apparatus according to claim 3, configured to perform:
initiating a timer in the terminal; and
wherein the timer is initiated in response to providing the further measurement report to the serving cell.

7. The apparatus according to claim 3, configured to perform:
in response to providing the further measurement report, receiving a further message from the serving cell, wherein the further message comprises an indication for the terminal to activate the configuration for the conditional handover;
activating the configuration for the conditional handover; and
stopping the timer.

8. The apparatus according to claim 3, configured to perform:
in response to the timer expiring before receiving a further message from the serving cell, activating a further configuration for a further measurement event; and
performing measurements on one or more neighbour cells according to the further configuration for the further measurement event.

9. The apparatus according to claim 3, configured to perform:
in response to providing the further measurement report, receiving a further message from the serving cell, wherein the further message comprises a further configuration for a conditional handover that is different to the stored configuration for the conditional handover;
activating the further configuration for the conditional handover; and
stopping the timer.

10. (canceled)

11. The apparatus according to claim 1, configured to perform:
receiving the threshold value from the serving cell.

12. The apparatus according to claim 1, wherein the measurement event configuration is for an A2 measurement event.

13. An apparatus for a serving cell, the apparatus comprising—: one or more processors, and memory storing instructions that, when executed by the one or more processors, cause the apparatus to perform:
providing a message to a terminal, wherein the message comprises a configuration for a measurement event and a configuration for a conditional handover, the configuration for the measurement event comprising a leaving condition; and
receiving a measurement report from the terminal, wherein the measurement report indicates that the leaving condition of the measurement event has been met a threshold value number of times at the terminal.

14. The apparatus according to claim 13, configured to perform: providing a configuration for the terminal to deactivate the received configuration for the conditional handover when the terminal determines that the leaving condition has been met a threshold value number of times.

15. The apparatus according to claim 13, configured to perform:
in response to receiving the measurement report, providing a release message to one or more target cells, the release message indicating for the one or more target cells to release the resources associated with the configuration for the conditional handover.

16. The apparatus according to claim 13, wherein the configuration for the measurement event comprises an entering condition, wherein the apparatus is configured to perform:
receiving a further measurement report from the terminal, the further measurement report indicating that the entering condition of the measurement event has been met.

17. The apparatus according to claim 13, configured to perform:
providing a request message to the one or more target cells, the request message requesting that the previously configured, configuration for the conditional handover for the terminal, is activated.

18. The apparatus according to claim 13, configured to perform:
receiving an acknowledgement message from the one or more target cells, the acknowledgement message indicating that: the configuration for the conditional handover is activated, and the associated resources have been reserved at the one or more target cells.

19. The apparatus according to claim 18, configured to perform:
in response to receiving the acknowledgement message, providing a further message to the terminal, wherein the further message comprises an indication for the terminal to activate the configuration for the conditional handover.

20. The apparatus according to claim 18, configured to perform:
receiving a negative acknowledgement message from the one or more target cells, the negative acknowledgement message indicating that the configuration for the conditional handover has not been activated.

21-23. (canceled)

24. A method performed by a terminal, the method comprising:
receiving a message from a serving cell, wherein the message comprises a configuration for a measurement event and a configuration for a conditional handover, the configuration for the measurement event comprising a leaving condition;
in response to measuring the leaving condition of the measurement event being met, incrementing a counter; and
when it is determined that the counter has reached a threshold value, deactivating the received configuration for the conditional handover and providing a measurement report to the serving cell, the measurement report indicating that the leaving condition of the measurement event has been met the threshold value number of times.

25-27. (canceled)
